(19) United States
(12) Patent Application Publication
(10) Pub. No.: US 2008/0171562 A1
(43) Pub. Date: Jul. 17, 2008

(54) System and method to access and download data from a mobile device using a cellular network

(75) Inventor: Romeshkumar Bharatkumar Mehta, Bangalore (IN)

Correspondence Address: WEINICK & ASSOCIATES, LLC, 615 WEST MOUNT PLEASANT AVENUE, LIVINGSTON, NJ, 07039, US

(73) Assignee: Agere Systems Inc.

(21) Appl. No.: 11/654,169

(22) Filed: Jan. 16, 2007

(51) Int. Cl. H04Q 7/20

(52) U.S. Cl. 455/466

(57) ABSTRACT

A method and system for accessing and downloading data stored on a first mobile device by a second device over a cellular network is provided. First, a request is received from the second device for access to data on the first device. The request is then transmitted to the first mobile device and a communications link is established over the cellular network between the first mobile device to the second device. Access is provided to the second device to the data stored on the first mobile device. The data may also be downloaded from the first mobile device to the second device.

### BACKGROUND OF THE INVENTION

The present invention relates to a system and method for accessing and downloading data over a cellular network, and, more specifically, to a system and method for accessing and downloading data over a cellular network from a mobile device.

Technological advances in mobile devices, such as cellular telephones, PDAs, and the like, allow the devices to perform many functions such as gaming, digital photography, audio reproduction, communications such as internet connection, and many other functions. Therefore, the portable devices have become multi-functional devices and have many uses.

The mobile devices have the ability to store large amounts of data. This data may be downloaded from another source, transmitted to the mobile device or be created on the mobile device itself. Currently, data stored on a mobile device may be sent to other users via a cellular network.

Also, since the data must be sent, all the received data must be stored on all recipients' mobile devices. This reduces the available or free memory on the mobile device. Also, the availability of data is dependent on the transmission of the data by the mobile device on which the data is stored. Therefore, access to the data is restricted.

### BRIEF SUMMARY OF THE INVENTION

We have recognized that currently there is not a way for a user to access or download data from a mobile device using a cellular network. As such, there is a need for a method for accessing and downloading data from a mobile device over a cellular network.

In accordance with one embodiment of the invention, data stored on a first mobile device is accessed by a second device over a cellular network. First, a request is received from the second device for access to data on the first device. The request is then transmitted to the first mobile device and a communications link is established over the cellular network between the first mobile device and the second device.

In one embodiment, access is provided to the second device to the data stored on the first mobile device. The data may also be downloaded from the first mobile device to the second device.

In another embodiment, the request may be authenticated in order to ensure the authenticity of the requesting user. The authentication is performed by both the cellular network and by the first mobile device. The request may also be granted or denied by the first mobile device allowing the user of the first device to have control over the access or downloading of the data on the first device. This may be done without first mobile device user's intervention each time there is an access.

Accessing or downloading the data is accomplished according to restrictions from the first mobile device thereby allowing the user of the first mobile device to set rules for the accessing and downloading of the data. Accessing or downloading the data is aborted if invalid access is attempted on the first mobile device.

These and other advantages of the invention will be apparent to those of ordinary skill in the art by reference to the following detailed description and the accompanying drawings.

### BRIEF DESCRIPTION OF THE DRAWINGS

FIG. 1 is a block diagram illustrating a mobile communication system according to one embodiment of the present invention;

FIG. 2 is a flowchart detailing the steps to access data on a mobile communications device according to one embodiment of the present invention;

FIG. 3 is a high-level block diagram of a cellular network switch which may be used in an embodiment of the invention; and

FIG. 4 is a high-level block diagram of a mobile device which may be used in an embodiment of the invention.

### DETAILED DESCRIPTION

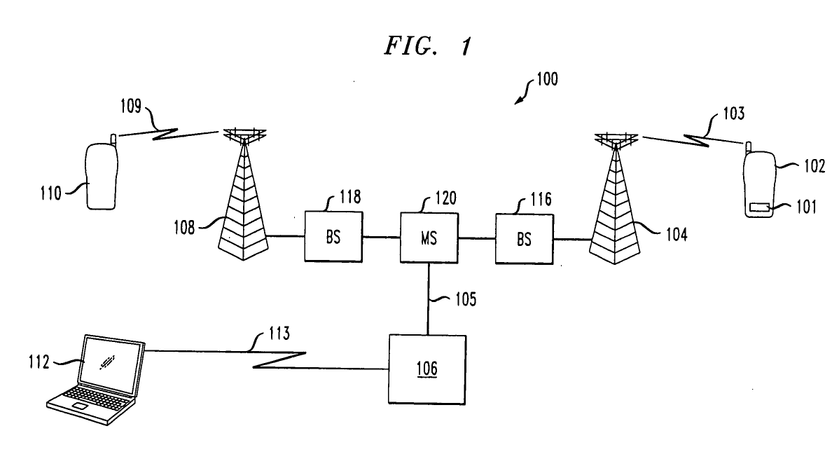

Referring now to FIG. 1 there is shown a block diagram illustrating a mobile communication system for accessing and downloading data from a mobile device over a cellular network according to one embodiment of the present invention. Communications system 100 comprises a first mobile device 102. The first mobile device 102 may be any mobile communications device such as a PDA or a cellular phone, which communicates via any type of cellular network. The first mobile device 102 contains data 101. The data 101 may be any type of data stored on any type of storage device or media that is part of or connected to the first mobile device 102. A first cellular tower 104 is shown connected to a first cellular base station 116. The first cellular base station 116 is connected to a cellular mobile switch 120. The first mobile device 102 communicates with the first cellular tower 104 via a first radio signal 103. The first cellular tower 104 communicates with the first cellular base station 116 and the first cellular base station 116 communicates with the cellular mobile switch 120. The first cellular tower 104, the first cellular base station 116 and the cellular mobile switch 120 form a cellular network.

A network 106 is connected to the cellular mobile switch 120. The network may be a cellular telephone network, the internet, a public telephone network, or any other public data or voice network. The cellular mobile switch 120 is connected to the network 106 via a network connection 105. The network connection 105 may be any type of connection connecting the cellular mobile switch 120 the network 106.

A second mobile device 110 is provided. The second mobile device 110 may be any mobile device, which communicates via any type of wireless network, such as a cellular network. A second cellular tower 108 is shown. The second mobile device 110 communicates with the second tower 108 via a second radio signal 109, as part of a cellular or other wireless network.

The second tower 108 is connected to a second base station 118. The second base station 118 is connected to the cellular mobile switch 120. As stated above, the cellular mobile switch 120 is connected to the network 106.

A stationary device 112 is connected to the network 106 via a second network connection 113. The stationary device 112 may be any stationary device which communicates via any type of wired network. The stationary device 112 communicates with the network 106 via the second network connection 113. The second network connection 113 may be any type of connection connecting the stationary device 112 to the network 106.

Accordingly, a connection may be made between the second mobile device 110 and the first mobile device 102 through the cellular mobile switch 120. A connection may also be made between the stationary device 112 and the first mobile device 102 through the network 106. This allows either the second mobile device 110 or the stationary device 112 to communicate with the first mobile device 102. Also, the first mobile device 102 may connect to and communicate with either the second mobile device 110 or the stationary device 112. In the rest of the application, any and all references to either the second mobile device 110 or the stationary device 112 will also describe the other.

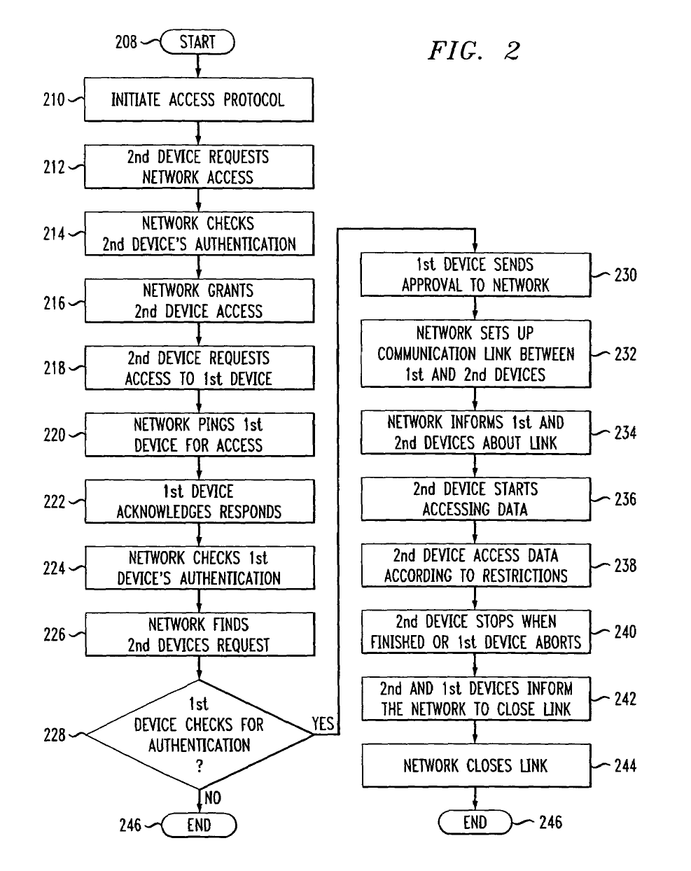

FIG. 2 is a flowchart showing the steps to access and download data on a mobile communications device over a cellular network according to one embodiment of the present invention. The process starts at step 208. In step 210, a user of the second mobile device 110 who wants to access data from the first mobile device 102, initiates relevant access protocols with the network 106. These are the same access protocols that a cellular phone now uses to access a cellular network. In step 212, the second mobile device 110 sends a request to cellular mobile switch 120 for access. This request may or may not contain the authentication required for first mobile device 102 based on the actual protocols of the cellular mobile switch 120.

In step 214, the network checks the second mobile device's 110 authentication. This is similar to existing protocols for making phone calls over a cellular network or any other communications service.

After cellular mobile switch 120 verifies the second mobile device's 110 authentication, it grants the second mobile device's 110 request to access the cellular mobile switch 120 in step 216. This may include only the acknowledgement to the second mobile device 110 and a resource allocation to the second mobile device 110 or it may also include pinging the first mobile device 102 (in the case where authentication information for the first mobile device 102 was also sent to the network).

Next, in step 218, the second mobile device 110 requests access to the first mobile device 102. Then, in step 220, the cellular mobile switch 120 will ping the first mobile device 102 for access.

In step 222, the first mobile device 102 acknowledges the request and sends its network authentication information to the cellular mobile switch 120 to be verified by the cellular mobile switch 120. In step 224, the cellular mobile switch 120 checks the first mobile device's 102 authentication.

Once this verification of the authentication is completed, in step 226, the cellular mobile switch 120 forwards the second mobile device's 110 request for access to first mobile device 102 for authentication. Then, in step 228, the first mobile device 102 checks the authentication of the second mobile device 110. This process is application based and may be implemented in various ways that are known in the art.

Only when first mobile device 102 authenticates the second mobile device 110 can the actual data transmission begin. If authentication fails, the first mobile device 102 indicates this to the cellular mobile switch 120 and the cellular mobile switch 120 forwards this information to the second mobile device 110. At this point, the communications link will not be setup and the process ends at step 246.

If the authentication of the second mobile device 110 is verified by the first mobile device 102 in step 228, the first mobile device 102 send approval to the cellular mobile switch 120 in step 230. Then, in step 232, the cellular mobile switch 120 sets up a communications link, which may be dedicated link (as in case of voice call) or packet based link (as in case of data call), over the cellular mobile switch 120 between the second mobile device 110 and the first mobile device 102. Then, in step 234, the cellular mobile switch 120 informs the second mobile device 110 and the first mobile device 102 about the communications link.

In step 236, the second mobile device 110 logs on to the first mobile device 102. This can be done using password based or direct access after previous authentication (depending upon the security setup on the first mobile device 102. Then the second mobile device 110 can start accessing, writing and/or downloading data from and sending data to the first mobile device 102. In step 238, the second mobile device 110 accesses, downloads, views, writes and/or copies data from the first mobile device 102 and may also send or deposit data to the first mobile device 102 based on access restrictions of the first mobile device 102. Many areas of memory, storage and data may be defined in the first mobile device 102 such as public, read-only, writeable, protected, hidden, etc. according to the first mobile device's 102 user preferences and the access to these different areas are controlled by different access restrictions for each area.

In step 240, when the data transfer is completed, the second mobile device 110 stops the data transfer. The second mobile device 110 may acknowledge the completion to both the first mobile device 102 and the cellular mobile switch 120. If an access violation or error occurs or an invalid process is requested, the first mobile device 102 can abort the data transfer.

In step 242, the first mobile device 102 and/or the second mobile device 110 informs the cellular mobile switch 120 to close the link. The first mobile device 102 will always be able to override both the cellular mobile switch 120 and the second mobile device 110 to stop data transfer and close the communication link for security reasons.

When signaled to close the link, the cellular mobile switch 120 closes the communication link and sends an acknowledgement to both the second mobile device 110 and first mobile device 102. The process ends at step 246.

In the method described above, data may be accessed, written to and or downloaded from a first mobile device over a cellular network. A second mobile device requests access to the network, and after it is authenticated, requests access to the first mobile device. The first mobile device may either grant or deny the request. If the request is granted and authenticated, the cellular mobile switch sets up a communications link. Then, the second mobile device may access and/or download data from the first mobile device. When finished, the communications link is closed.

In one embodiment, both the first mobile device and the second mobile devices are cellular devices. In a second embodiment, the first mobile device is a cellular phone, which is linked through a cellular network to a network. The second device is a stationary device attached through a wired connection to the network, which may be the internet or the public telephone network.

The communications system described herein may be implemented using appropriately programmed cellular mobile switch and mobile devices. Such cellular mobile switches and mobile devices are well known in the art, and may be implemented, for example, using well known processors, memory units, storage devices, computer software, and other components.

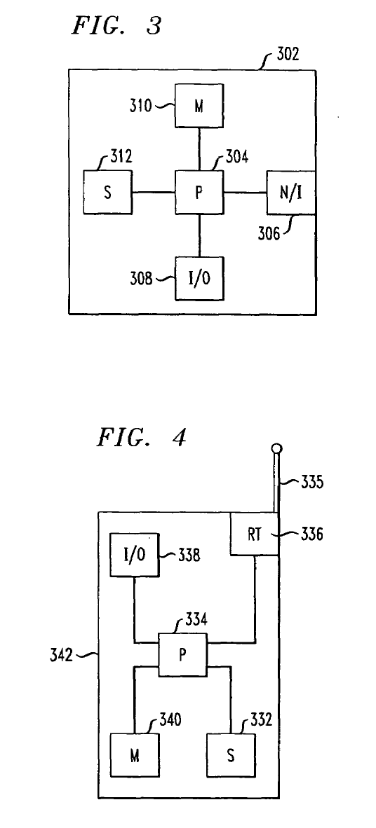

A high-level block diagram of an example of such a cellular mobile switch is shown in FIG. 3. Cellular mobile switch 302 contains a processor 304, which controls the overall operation of cellular mobile switch 302 by executing program instructions, which define such operation. The program instructions may be stored in a storage device 312 (e.g., flash RAM) and loaded into memory 310 when execution of the program instructions is desired.

Thus, the functioning of the cellular mobile switch will be defined by program instructions stored in memory 310 and/or storage 312 and the functioning will be controlled by processor 304 executing the program instructions. Cellular mobile switch 302 also includes one or more network interfaces 306 for communicating with other devices such as cellular base stations, (not shown). Cellular mobile switch 302 also includes input/output 308, which represents devices which allow for user interaction with the cellular mobile switch 302 (e.g., display, keyboard, mouse, speakers, buttons, etc.) One skilled in the art will recognize that an implementation of an actual phone will contain other components as well, and that FIG. 3 is a high level representation of some of the components of such a cellular mobile switch for illustrative purposes.

A high-level block diagram of an example of such a mobile device is shown in FIG. 4. Mobile device 342 contains a processor 334, which controls the overall operation of mobile device 342 by executing program instructions, which define such operation. The program instructions may be stored in a storage device 332 (e.g., flash RAM) and loaded into memory 340 when execution of the program instructions is desired.

Thus, the functioning of the mobile device 342 will be defined by program instructions stored in memory 340 and/or storage 332 and the functioning will be controlled by processor 334 executing the program instructions. Mobile device 342 also includes one or more radio transceivers 336 and an antenna 335 for communicating with other devices via RF transmission. Mobile device 342 also includes input/output 338 which represents devices which allow for user interaction with the mobile device 342 (e.g., display, keyboard, mouse, speakers, buttons, etc.).

One skilled in the art will recognize that an implementation of an actual phone will contain other components as well, and that FIG. 4 is a high level representation of some of the components of such a phone for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for accessing data stored on a first mobile device, communicating via a cellular network, by a second device comprising the steps of:
receiving a request from the second device for access to data stored on the first device;
transmitting the request to the first mobile device over the cellular network; and
establishing a communications link between the first mobile device and the second device, the communication link comprising at least in part the cellular network.

2. The method of claim 1 further comprising the step of providing access to the second device to the data on the first mobile device.

3. The method of claim 1 further comprising the step of the cellular network authenticating the request.

4. The method of claim 1 further comprising the step of the first mobile device authenticating the request.

5. The method of claim 1 further comprising granting the request by the first mobile device.

6. The method of claim 1 further comprising downloading the data from the first mobile device to the second device.

7. The method of claim 1 wherein the second device is a mobile device.

8. The method of claim 2 wherein the step of providing access to the second device to the data on the first mobile device is accomplished according to restrictions from the first mobile device.

9. The method of claim 1 further comprising writing data to the first mobile device.

10. A method for accessing data stored on a first mobile device, communicating via a cellular network, comprising the steps of:
sending a request for access to data stored on the first device; and
establishing a communications link to the first mobile device, the communication link comprising at least in part the cellular network.

11. The method of claim 10 further comprising the step of accessing the data on the first mobile device.

12. The method of claim 1 further comprising downloading the data from the first mobile device.

13. A method for allowing data to be accessed by a second device comprising the steps of:
receiving a request from the second device for access to the data over a cellular network; and
establishing a communications link to the second device, the communication link comprising at least in part a cellular network.

14. The method of claim 13 further comprising the step of providing the second device access to the data.

15. The method of claim 13 further comprising the step of authenticating the request.

16. The method of claim 13 further comprising granting the request.

17. The method of claim 13 further comprising downloading the data to the second device.

18. The method of claim 13 wherein the second device is a mobile device.

19. The method of claim 14 wherein the step of providing access to the second device to the data is accomplished according to restrictions.

20. The method of claim 19 wherein the step of providing access to the second device to the data comprises allowing data to be written.

21. A system for accessing data stored on a first mobile device, communicating via a cellular network, by a second device comprising:
means for receiving a request from the second device for access to data on the first device;
means for transmitting the request to the first mobile device over the cellular network; and
means for establishing a communications link between the first mobile device and the second device, the communication link comprising at least in part the cellular network.

22. The system of claim 21 further comprising means for providing access to the second device to the data on the first mobile device.

23. The system of claim 21 further comprising means for the cellular network authenticating the request.

24. The system of claim 21 further comprising means for the first mobile device authenticating the request.

25. The system of claim 21 further comprising means for granting the request by the first mobile device.

26. The system of claim 21 further comprising means for downloading the data from the first mobile device to the second device.
